(19) United States
(12) Patent Application Publication
(10) Pub. No.: US 2013/0197854 A1
(43) Pub. Date: Aug. 1, 2013

(54) SYSTEM AND METHOD FOR DIAGNOSING MACHINE TOOL COMPONENT FAULTS

(71) Applicant: Linxia Liao, Plainsboro, NJ (US)

(72) Inventor: Linxia Liao, Plainsboro, NJ (US)

(73) Assignee: Siemens Corporation, Iselin, NJ (US)

(21) Appl. No.: 13/744,792

(22) Filed: Jan. 18, 2013

Related U.S. Application Data
(60) Provisional application No. 61/592,182, filed on Jan. 30, 2012.

(51) Int. Cl. G06F 17/18

(52) U.S. Cl. CPC G06F 17/18
USPC 702/130; 702/181; 702/141; 702/145; 702/142

(57) ABSTRACT

A machine tool system is diagnosed by identifying a fault class to which an input measurement vector belongs. The fault class corresponds to a group of weight vectors in a code book of a self organized map that describes the machine tool system based on training data. Probabilities that the input measurement vector belongs to a given class are estimated based on the posterior probability of the weight vectors of the code book corresponding to the given class given the input measurement vector. Training data to create the code book may be collected under a first operating condition while the input measurement vector is collected under a second operating condition.

### CLAIM OF PRIORITY

This application claims priority to, and incorporates by reference herein in its entirety, pending U.S. Provisional Patent Application Ser. No. 61/592,182, filed Jan. 30, 2012, and entitled “Machine Tool Feed Axis Health Monitoring Using Plug-and-Prognose Technology.”

### FIELD OF THE INVENTION

This invention relates generally to techniques for machine monitoring. More particularly, the invention relates to diagnosing a machine problem by determining a class likely to include a set of monitoring data.

### BACKGROUND OF THE INVENTION

Operational safety, maintenance, cost effectiveness, and asset availability have a direct impact on the competitiveness of organizations. In order to address issues associated with maintenance-related machine downtime, various maintenance strategies have been adopted over the years. One of the most desirable approaches is condition based maintenance (CBM). Machine tools are highly complex and their systems are very often subjected to varying speeds and working conditions that make health monitoring and assessment strategies difficult to implement.

### SUMMARY OF THE INVENTION

The present invention addresses the needs described above by providing a method for identifying a fault class to which an input measurement vector belongs, the fault class corresponding to at least one weight vector in a code book of a self organized map describing a system based on training data. The method includes estimating a density of a Gaussian mixture model distribution defined by the code book; determining a posterior probability of each weight vector of the code book given the input measurement vector; and estimating each probability that the input measurement vector belongs to a given class, based on the posterior probability of the at least one weight vector of the code book corresponding to the given class given the input measurement vector.

In another aspect of the invention, a non-transitory computer-usable medium is provided having computer readable instructions stored thereon for execution by a processor to perform operations for identifying a fault class to which an input measurement vector belongs, as described above.

### BRIEF DESCRIPTION OF THE DRAWINGS

FIG. 1 is a flowchart showing an anomaly detection and diagnosis technique according to one embodiment of the invention.

FIG. 2 is a schematic view of a test bed for testing a system in accordance with an embodiment of the invention.

FIG. 3 is a schematic view of a machine tool configuration for testing a system in accordance with an embodiment of the invention.

FIG. 4 is a graph showing a single digit health indicator measured for a plurality of known fault occurrences in sequential time, in accordance with one embodiment of the invention.

FIGS. 5A, 5B and 5C are graphs showing sensitivity analyses for three different proposed health indicators, plotted for five different fault conditions, in accordance with one embodiment of the invention.

FIG. 6 is a graph showing a time series of MQE measurements indicating cutting tool degradation, in accordance with one embodiment of the invention.

FIG. 7 is a graph showing a time series of temperature measurements indicating machine warm-up, in accordance with one embodiment of the invention.

FIG. 8 is a graph showing variations from a baseline MQE, for nine different installations of the same components, in accordance with one embodiment of the invention.

FIG. 9 is a flow chart showing a method in accordance with one embodiment of the invention.

FIG. 10 is a schematic diagram showing a computer system in accordance with one embodiment of the invention.

### DESCRIPTION OF THE INVENTION

Unexpected downtime is still a big issue impacting productivity and total cost of ownership in the manufacturing industry. Early detection of emerging faults and degradation trends can prevent downtime, target maintenance efforts, increase productivity and save costs. Condition-based maintenance systems in manufacturing plants continuously deliver data related to the machine's status and performance, but the challenge for field engineers and management staff is making effective use of the huge amount of data to accurately detect equipment degradation.

Two analysis approaches are generally available to the engineer: model-based analysis and data driven analysis. Physics-based modeling of machines and other equipment provides good insight into mechanical mechanisms and produces very accurate prognostic information if the machine is well understood. A well-built model, however, may not be easily adaptable to other machines, especially complex machines. The alternative, data-driven approach provides reasonable prognostic information when data is abundant and can be more easily reused on other machines or equipment. Data-driven approaches, however, can be difficult to implement and maintain due to lack of expertise in data analysis and lack of adaptability to changes in machine usage (changing baselines).

A review of the current literature indicates that there has been a strong interest in machine health characterization and prognostics for safety and maintenance purposes. However, despite the progress to date, there are still many practical issues that have been insufficiently addressed. Those issues include but are not limited to false alarms introduced by operating condition changes instead of machine degradation, dynamics during machine warm-up time and inexplicit baseline shift due to maintenance adjustment or replacement. Without taking these practical issues into consideration, the implementation of the anomaly detection and diagnosis models has been largely limited in real applications.

The presently described technology was developed to address the shortcomings of conventional data-driven approaches by packaging automated, modularized, and customizable data-driven algorithms together in a way that automatically identifies the best analysis model parameters and adapts to different machine types and usages. The resulting system converts a large amount of machine specific data into reliable and easy-to-understand machine health information, without complex machine modeling or parameterization.

The described system was installed on two test beds: a feed axis system and a vertical machining center. The feed axis is a typical subsystem of a machine tool which plays an active role in generating the geometry of the work pieces being machined. The feed axis test bed allowed for very controlled tests and for inducing actual faults that otherwise would have affected a machine tool. Once the technology was validated on the feed axis test bed, a number of tests were conducted on an actual machine tool.

Faults were initially induced on the feed axis test bed to reliably detect a mechanical anomaly, to correctly identify the fault type, to determine if the use of controller data provides a significantly better detection and identification, and to determine if this assessment and fault detection be done without any machine specific parameter setting. Once that step was completed, the evaluation of the technology was conducted with respect to the ability to communicate with the machine control without any significant changes brought to the existent machine/control configuration, the ability to collect data as intended from both the machine tool control and added sensors, the ability to capture and represent normal operation state of the machine, and the ability to capture and diagnose operating states deemed as abnormal.

The present disclosure presents additional development and tests completed based on the previous results. Additionally, insights concerning test design, findings, and issues encountered through the experimental work are presented.

Data Analysis Approach:

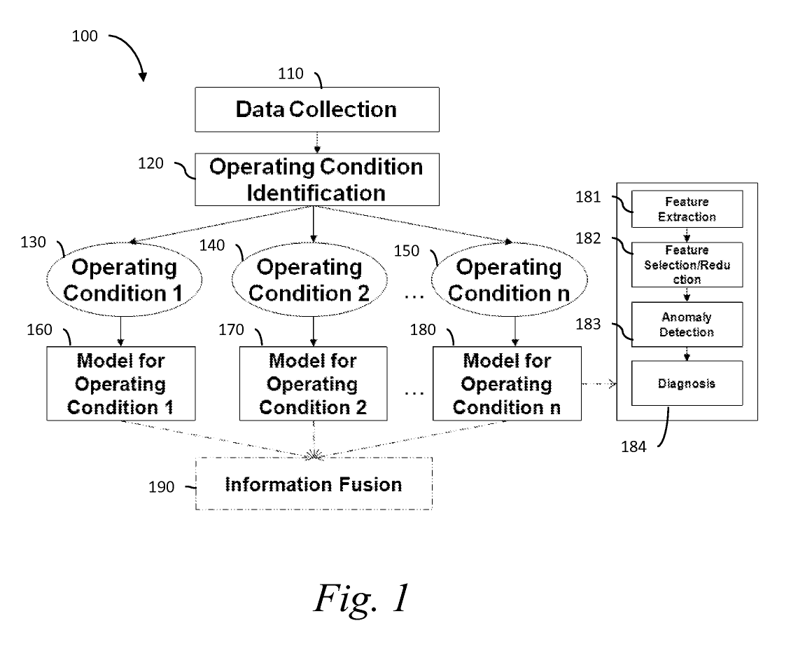

Instead of solving the diagnosis problem by finding complex boundaries in a combination of multiple operating conditions, the proposed methodology divides the complex problem into multiple regimes and conquers the problem within each regime. A flowchart of the data analysis method 100 is presented in FIG. 1. After data from both external sensors and machine controller is collected at block 110, the first step is to identify, at block 120, the operating conditions 130, 140, 150 based on the operational data obtained from the controller. An “operating condition,” as used herein, is a set of one or more conditions, other than a fault, that may influence measurements received from the sensors and the controller. One example of an operating condition is the set of conditions under which a particular cutting tool is used. Those conditions may include spindle speed, feed rates along each machine axis, and an index of a particular cutting tool. After initial training, a new data file is assigned to the most appropriate operating condition based on the operational data.

Models 160, 170, 180 are built for each of the labeled operating conditions 130, 140, 150 for anomaly detection and diagnosis. Results from the separate models may then be integrated at block 190 to better predict operating conditions for new operational data.

Each model contains four steps: feature extraction 181, feature selection/reduction 182, anomaly detection 183, and diagnosis 184. Feature extraction 181 is applied to sensor signals, such as vibration, to extract diagnosis-related features. Common methods for feature extraction include time domain analysis and fast Fourier transform. The feature selection/reduction operation 182 is two-fold. The purpose of feature selection is to identify the critical features/sensors that can provide the most useful information, while reducing noise and eliminating redundancy. Feature reduction does not reduce the number of sensors, but projects the original feature space into a new feature space in which different faults can be identified more clearly.

The feature space after feature selection/reduction is used as input to the anomaly detection algorithm 183 and the diagnosis algorithm 184. The anomaly detection algorithms 183 use data in normal condition as the baseline and detect outliers that do not conform to a defined criterion. If an anomaly is detected, the diagnosis function is triggered to find out the root cause of the anomaly. The health information within each operating condition can be integrated to represent an overall machine health. In the machine tool application used in developing the presently described technology, different operating conditions usually mean using different cutting tools. The information within each operating condition is kept separate for the purpose of indicating the health condition of each cutting tool.

A description of each operation in a model within an operating condition may be found in L. Liao and R. Pavel, “Machine Anomaly Detection and Diagnosis Incorporating Operational Data Incorporating Operational Data Applied to Feed Axis Health Monitoring,” ASME 2011 International Manufacturing Science and Engineering Conference, Corvallis, Oreg., USA, 2011 (“Liao and Paval”), the contents of which is incorporated by reference herein.

A primary element of the presently described technique for anomaly detection and diagnosis is the self organizing map (SOM). For anomaly detection, an unsupervised SOM is trained based on normal/baseline data. A new observation is tested with the baseline and a distance to the baseline is calculated as a machine health indicator. For diagnosis, a supervised SOM, which contains the fault patterns (labels of the data are incorporated in training), will be automatically set up using the faulty data. After the SOM is set up, it can be used for diagnosis when a new observation is obtained.

Applications of using SOM for anomaly detection and diagnosis may be found in L. Liao, H. Wang, and J. Lee, “Bearing Health Assessment and Fault Diagnosis Using the Method of Self-Organizing Map,” 61st Meeting of the Society for Machinery Failure Prevention Technology, 2007, the contents of which is incorporated by reference herein. A brief introduction to SOM and the definition of minimum quantization error (MQE), which is used as the machine health indicator, are provided below.

Let a p-dimensional input dataset be denoted as x=[x₁, x₁, . . . , xₚ]. Neuron j (j=1, 2, . . . , N) in the SOM, where N is the number of neurons, contains a weight vector represented by wⱼ=[wⱼ₁, wⱼ₂, . . . , wⱼₚ]. The Best Matching Unit (BMU) w_{c} is defined by the neuron whose weight vector is the closest to the input vector x. The distance from x to w_{c} is given by

|x−w_{c}|=min{|x−wⱼ|},j=1,2, . . . ,N.

This distance measure is the so called minimum quantization error (MQE). To train a SOM in an unsupervised manner, the weight vectors are updated by moving towards the input vectors according to a defined neighborhood kernel function. Similar to a neural network, the following learning rule is applied:

wⱼ(t+1)=wⱼ(t)+β(t)hⱼ(t)(x−wⱼ(t)),

where t is the iteration step, β(t) is the learning rate and hⱼ (t) is the neighborhood kernel function. The training iterates until a predefined stop criterion is met. In supervised training, the input vector is denoted as x=[x₁, x₁, . . . , xₚ, A_{q}]. A_{q} is a vector with length equal to the total number of classes. The vector contains only binary numbers with one at the place where the dataset belongs to the class and zeros at the remaining places.

Normally, the output of a diagnosis function is a class membership indicating to which class/fault the testing data belongs. It is also valuable to know how confidently the testing data belongs to a certain fault among all fault types. The presently described diagnosis function generates results decided by the largest probability of each fault type (class) given the testing data. The probability is calculated by considering a code book (weight vectors of all neurons in the map) of the SOM as a Gaussian mixture model distribution. First, the density of the distribution is estimated. Second, the posterior probability of each vector of the code book given each testing data is calculated. Finally, the probability of each class given each testing data is estimated based on the posteriors of all the code book vectors which belong to a certain class.

To construct a conditional density function p (x|j) for the code book of the trained SOM, the posterior possibility of each map unit given an input vector is

$$P ( j \vert x ) = \frac{p ( x \vert j ) P ( j )}{p ( x )} ,$$

where P (j) is the prior probability and p(x)=Σⱼp(x|j)P(j)

Here j=1, 2, . . . , N, where N is the size of the code book/neurons. The posterior probability of each fault type given an input vector is

P(c|x)=Σ_{∀j=c}P(j|x).

The probability (e.g. 99.43% End Bearing Misalignment 0.007″) can indicate how likely a previously experienced fault has happened.

Experimental Setup: Feed Axis Test Bed:

A machine tool feed axis system was considered for the initial investigations of the anomaly detection methodology. A feed axis test bed was built to allow application of actual degradations and faults without the risk of damaging an entire machine tool. The feed axis test bed was designed and built to allow easy implementation of considered failure modes, and quick change of ball screws, ball nuts, bearing supports and other key components.

The main components of the test bed are a Siemens 840Di controller (not shown), a motor and ball screw, a clutch, two bearings, the ball nut, and the linear guide ways. The ball nut moves a carriage guided by two linear ways over a distance of 15.75″ with a maximum speed of 1181 in/min.

Typical feed axis failure modes have been identified through literature studies and conversations with machine tool users and manufacturers. As a result of this study, various causes and scenarios of degradation and faults have been identified, including: wear, poor maintenance (lubrication issues), accidents resulting from electronic malfunction or operator error (crash), poor design, under-capacity, excessive preload, bent ball screw, misalignment (improper installation), and environmental conditions. In order to replicate some of the above mentioned issues, a number of fault and degradation tests have been considered.

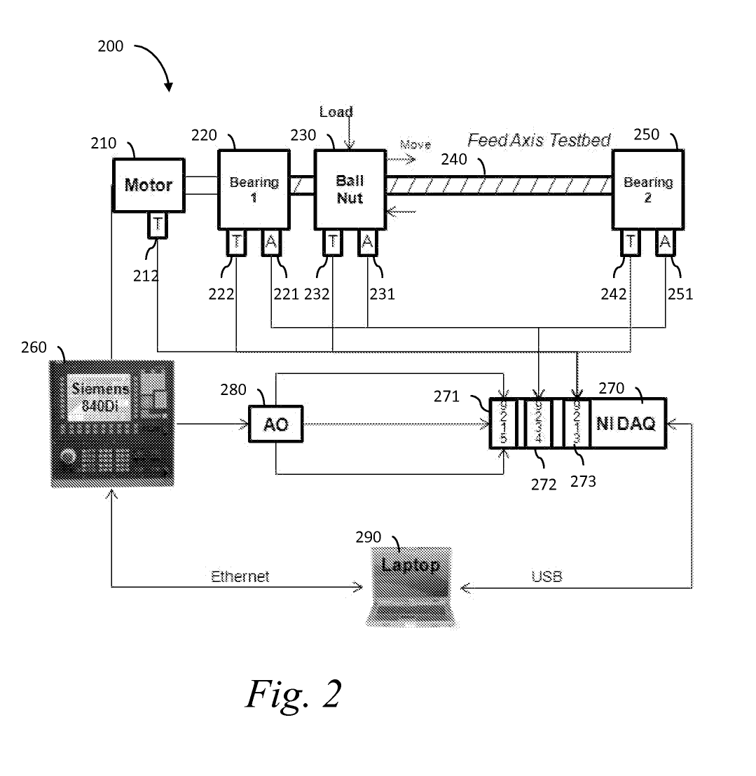

A relatively large number of sensors were installed on the feed axis test bed to avoid missing information that may prove important, and to determine which signals and location of sensors are significant for the fault/degradation detection process. An advantage of that configuration is that it permits testing if and what reduction methods can identify a smaller set of sensors without compromising the results of the analysis. A schematic of the data acquisition system 200 is presented in FIG. 2. The main components of the test-bed are a Siemens 840Di controller 260, a motor 210 and a ball screw 240, two bearings 220, 250, and a ball nut 230.

Two accelerometers 221, 251 (PCB model 607A11) were installed on the housings of the two bearings 220, 250, respectively. One accelerometer 231 was installed on the ball nut 230. Four type J thermocouples (elements 212, 222, 242, 232) were installed on motor 210, two bearings 220, 240 and ball nut 232, respectively. Three signals were output from the controller 260 through analog output modules (Siemens 135-4FB52-0ABO) sitting on a rack (Siemens ET200-S). A National Instruments (NI) data acquisition chassis 270 (NI cDAQ 9178), which includes 3 modules 271, 272, 273, was used to collect signal from the ten channels. Specifically, a NI 9234 module 272 was used to collect accelerometer data; an NI 9213 module 273 was utilized to acquire data from the thermocouples; and an NI 9215 module 271 was used to acquire the analog outputs 280 coming from the Siemens controller 260. Data acquisition software running on a laptop 290 communicates with the Siemens 840Di controller 260 through Ethernet to generate a trigger to collect data only when the axis is being operated. Data was collected from NI chassis 270 via a USB connection at a sampling rate of 5000 Hz. Three operational data channels were collected from the analog output 280 of the control (torque, speed, and encoder position) and other operational data was collected through the Ethernet. No human interference was required after starting the data acquisition software. As the axis was operating, data was collected and saved on the laptop 290 automatically.

In order to test the anomaly detection and fault diagnosis methodology, data was collected during normal operation conditions of feed axis, and for various faulty conditions. Faults such as end bearing misalignments of 0.002″ and 0.007″, a ball nut misalignment of 0.007″ and a bent ball screw, as well as combinations of those faults, were introduced to the test-bed as abnormal (fault) conditions. This set of misalignment conditions was intended to test the method's ability to detect anomaly for both small and large fault conditions. Besides the misalignment of ball bearings and ball nut, the test bed may be used for testing faulty conditions, such as: lubrication (reduced or excessive), load variation (different carriage load and external bi-directional loading), bent screw, pitting on screw, and contamination and corrosion.

Experimental Setup: actual machine tool

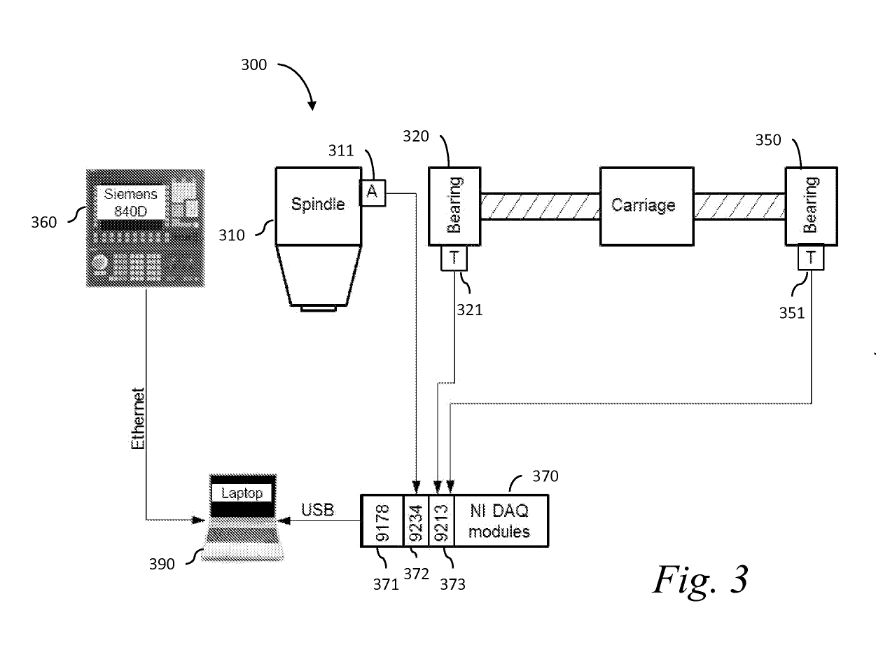

The technique of the invention was also tested using an actual machine tool. Specifically, a Deckel Maho DMU50 vertical machining center 300, shown schematically in FIG. 3, together with a Siemens 840D PowerLine control 360, were configured for testing the presently described machine diagnosis system. The DMU50 is capable of 18,000 rpm and 944 in/min feed rate. The machining center was instrumented with sensors targeting the main subsystems: the spindle 310 and the X axis. An accelerometer 311 was mounted on the spindle 310 and J-type thermocouples 321, 351 were installed on each of the X axis bearings 320, 350, respectively. Three modules 371, 372, 373 of a data acquisition chassis 370 are used to collect signals from the Siemens controller 360, the accelerometer 311 and the thermocouple 321, 351, respectively.

The decision to install only thermocouples on the X axis bearings 320, 350 is based on two reasons: first, tests conducted on the feed axis revealed that temperature and torque provide significant information about the state of the system even without support from accelerometers, and second, it is preferable that the number and value of added sensors is reduced, as significant information can be collected directly from the machine tool control. Other than having a smaller number of added sensors installed, the monitoring system installed on the DMU50 machining center is very similar to the system installed on the feed-axis test bed shown in FIG. 2. Another difference is acquisition of all controller data directly through the Ethernet connection, with no separate digital-to-analog conversion cards.

When monitoring the feed-axis test bed described above, it is relatively easy and risk-free to introduce various faults and degradations in the system. For the machine tool, however, the introduction of faults and degradations is neither easy nor desirable. A different strategy from that used in the case of the feed axis test bed was therefore adopted for the DMU50 machine. Specifically, a degradation situation was represented by a tool wear case. In addition, a number of simple faults, such as forced vibration or artificial heating of one bearing, were induced. Those results, however, are not discussed herein.

Design of Testing Procedures

A movement routine (referred as test) was run repeatedly on the feed axis test-bed. To validate whether it is necessary to automatically identify operating conditions, a number of tests were run with different loadings, speeds, and in alternative directions. A diagnosis model was trained, using the disclosed technique, with data collected under a single operating condition. The technique then automatically takes into consideration new operating conditions, and builds a new diagnosis model for each new operating condition. New data is first assigned to the most appropriate operating condition and then evaluated using the diagnosis model trained using data collected within that operating condition. Another analysis method will build a diagnosis model using data collected from only one of the operating conditions and test data from all possible operating conditions. In other words, a diagnosis model trained with data from only one operating condition may be used in evaluating data collected from either the same or different operating conditions.

In the experiment, each run contained three different feed rates for the ball nut to travel back and forth (two moving directions) on the axis. Three different masses were used to vary the loading conditions on the test bed's carriage. Data was collected under each combination of different feed rates, moving directions and weights.

In case of the DMU50 machine, two scenarios were considered. In one case, the machine was subjected to a moving routine that would provide a reference state for periodic checkup of the health state. That approach is used to capture the simple faults, and is not discussed in this disclosure. In another case, the machine was used to conduct tool wear tests and the normal, or reference, condition of the machine was given by the cut with fresh tool at the beginning of the tool wear trials. A pre-established number of passes were conducted with one end-mill into a steel block using the same cutting conditions.

Data Analysis Results: Feed Axis Health Monitoring and Anomaly Detection:

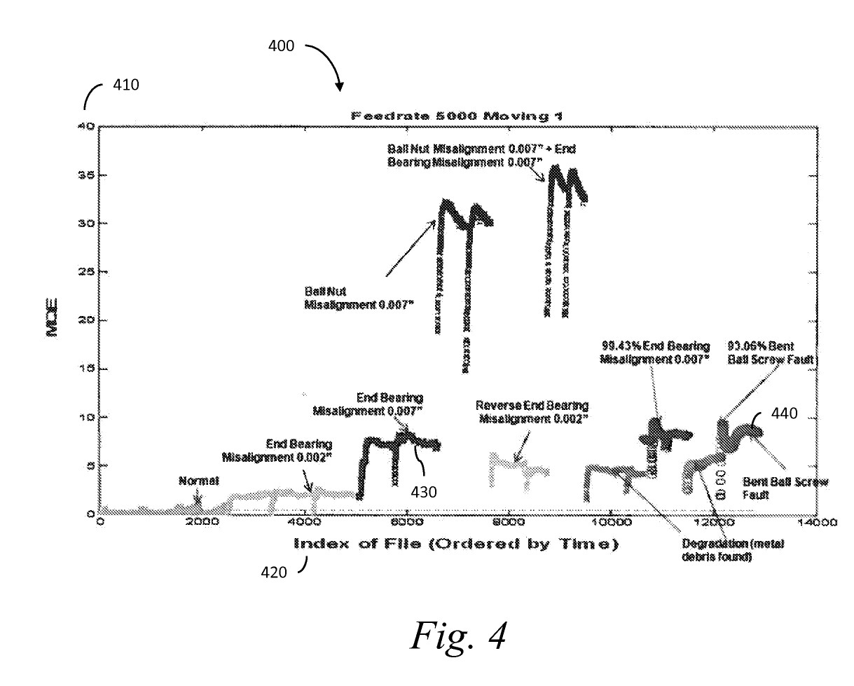

The following fault conditions of the feed axis were run:
Normal (no either misalignment or degradation)
End bearing misalignment 0.002″
End bearing misalignment 0.007″
Ball nut misalignment 0.007″
Reverse end bearing misalignment 0.002″
Ball nut misalignment 0.007″+end bearing misalignment 0.007″
Degradation (due to wear)
Bent ball screw
   All features from the selected sensors were converted into a single health indicator, the minimum quantization error (MQE), which is a distance measure of the deviation of the testing data from baseline by an unsupervised SOM. As shown in the graph 400 of FIG. 4, the MQE 410 clearly indicates different health statuses of the feed axis. Different health conditions in the graph 400 are indicated by labels, and can be distinguished by different levels in terms of MQE. The tests were conducted at different times and the collected files are represented in chronological order 420 in the chart. It is noted that the MQE levels for end bearing misalignment 0.007″ (pattern 430) and bent ball screw (pattern 440) are similar, while the probability of fault types indicates how likely a previously seen fault has happened.

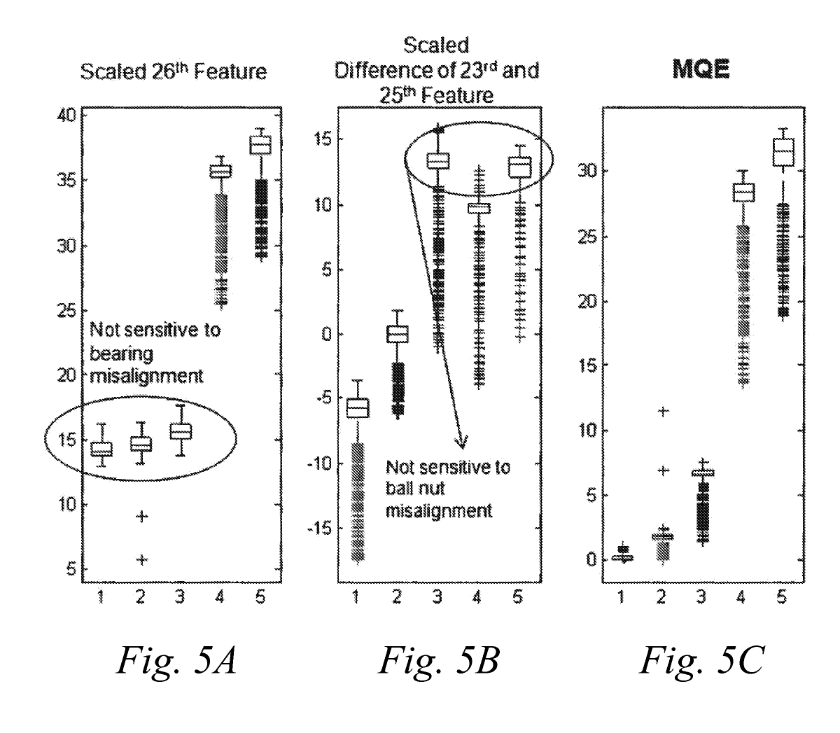

A sensitivity analysis, graphically illustrated in FIGS. 5A, 5B and 5C, was conducted to find out whether MQE (FIG. 5C) outperforms the raw signals that were identified as critical sensors using principal component analysis as described in Liao and Paval. The previous results contained health status of normal (indicated as fault “1” on the horizontal axis of FIGS. 5A, 5B and 5C), end bearing misalignment of 0.002″ (fault “2”), end bearing misalignment of 0.007″ (fault “3”), and ball nut misalignment of 0.007″ (fault “4”). This discussion compares results from additional tests conducted on the feed-axis test bed. One of the first additional faults induced on the feed-axis was a combination of end bearing misalignment of 0.007″ and ball nut misalignment of 0.007″ (fault “5”). That fault was chosen to test whether the identified features are sensitive to the combination of known faults as well, and whether any difference can be detected as compared to previous fault representations using MQE. From the viewpoint of data processing, the differences among temperatures as raw signals in were added in the process of identifying critical sensors. The results indicated that feature 26th (torque) (shown in FIG. 5A) and the difference of feature 23rd and 25th (end bearing temperature on each side) (shown in FIG. 5B) contribute most to the first and second scores. Hence, they were considered as critical sensors.

The task is to find out how well those identified critical sensors and MQE are indicative of faults. To compare the features/raw signals with the MQE within a reasonable scale, the following scaling function was applied. For each feature or MQE (denoted by f, apply:

$$f = f \times \frac{max ( MQE ) - min ( MQE )}{max ( f ) - min ( f )}$$

In the box plots of FIGS. 5A, 5B and 5C, the central horizontal line in each box is the median, and the edges of the box are the 25th and 75th percentiles. The whiskers extending to the most extreme data points are considered outliers, and outliers are plotted individually. By default, the maximum whisker length w=1.5. Points are drawn as outliers if they are larger than q3+w(q3−q1) or smaller than q1−w(q3−q1), where q1 and q3 are the 25th and 75th percentiles, respectively. The default of 1.5 corresponds to approximately +/−2.7 a and 99.3% coverage if the data is normally distributed.

FIG. 5A shows that feature 26th is sensitive to differentiating bearing misalignment and ball nut misalignment, while it is not sensitive to different levels of bearing misalignment. FIG. 5B shows that the difference of feature 23rd and 25th is sensitive to different levels of bearing misalignment, but is not, however, sensitive to ball nut misalignment faults. FIG. 5C shows MQE is sensitive to both different levels of bearing misalignment and ball nut misalignment. In other words, MQE reliably detects all failure modes with a smaller possibility of missing an event of the failure mode. Moreover, MQE automatically yields an optimized way to combine several measurement quantities into one indicator, which saves users from the tedious work of looking at very large amounts of measurement data.

Data Analysis Results: Cutting Tool Degradation Tracking

The same analysis methods were also applied to the tests conducted on the DMU50 machine. The vibration signals were used as input in this case. Operating condition (in this case, cutting tool) identification is obviously necessary since the combination of spindle speed and feed rate varies for different cutting tools. Hence, the vibration measurement varies and must be compared with the correct baseline.

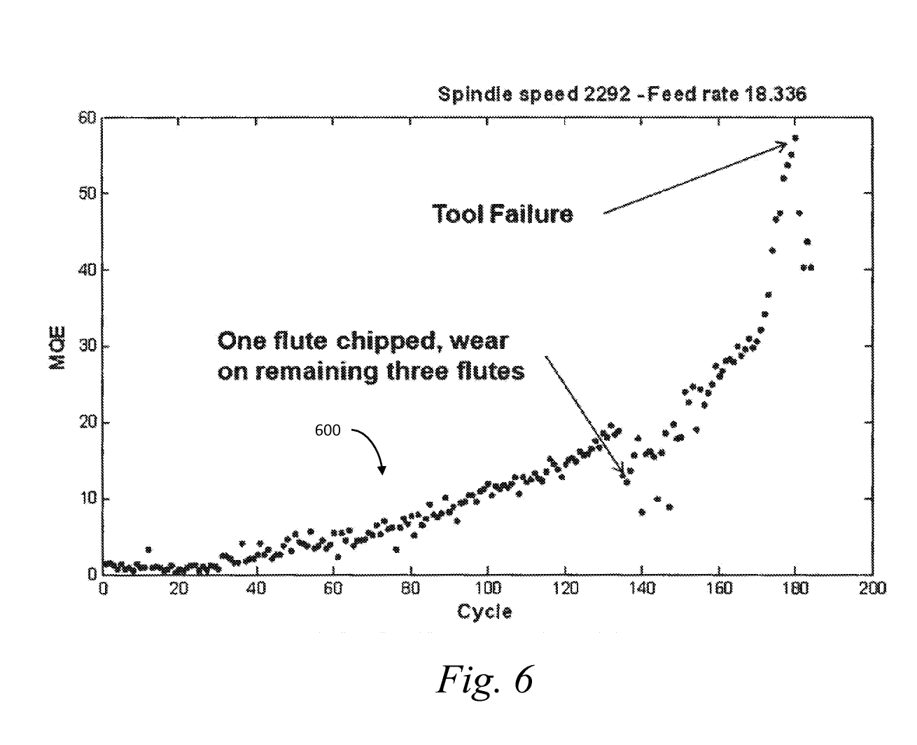

An entire history 600 of the life cycle of one of the cutting tools in the experiment is shown in FIG. 6. From the total of 185 passes, the data collected for the first 30 passes was used as training data to build the baseline. The remaining data was compared against the baseline and the distance measure MQE was calculated and displayed. There was a clear increasing trend in MQE from the beginning of life cycle until the end of life. At pass 140, there was a dramatic disturbance of MQE because one of the flutes was chipped. The cutting tool continued to wear on the remaining three flutes. After that event, the MQE increased even faster until the end of life.

Discussion: Machine Warm-up Issues and Feature Selection

Due to the fact that the thermal expansion of different machine tools varies, the temperature measurements cannot be scaled linearly. The ambient temperature also affects the machine tool thermal expansion, unless shielded from the environment. To allow the machine to reach thermal equilibrium, most machines require a warm-up time.

As mentioned previously, the test bed was kept running from morning until the afternoon, for approximately 8 hours. By looking at the raw signals, it was found that the temperature measurements went through a similar pattern for each day's experiment. The temperature measurement increased faster at the beginning of the test in the morning. After about one and a half hours, the increase in temperature slowed down, and the temperature measurements became stable (flattened out) throughout the afternoon.

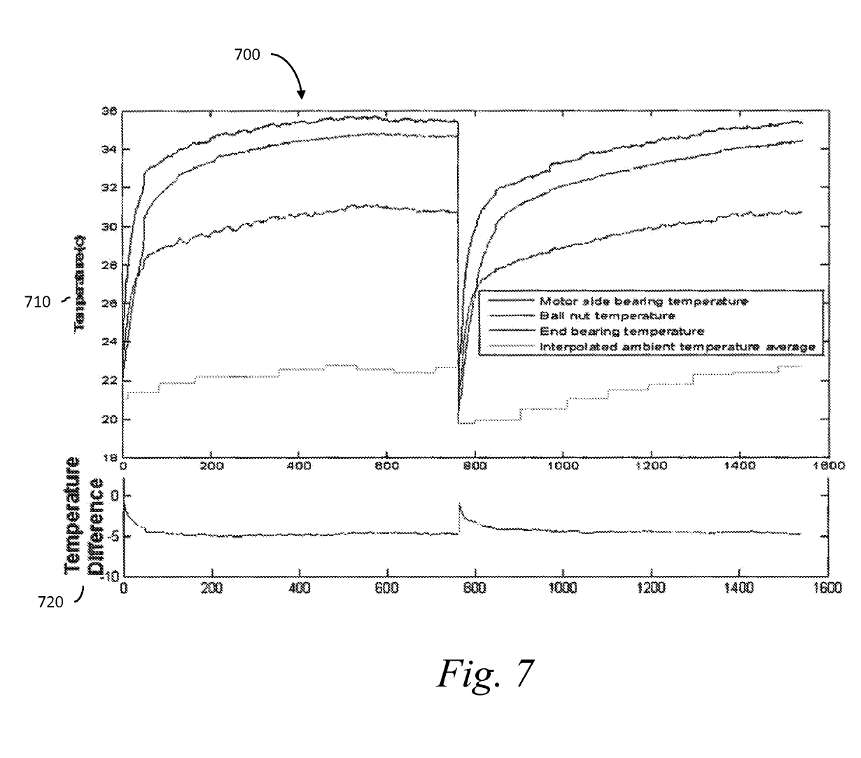

A graph 700, shown in FIG. 7, illustrates temperature data taken on a test machine over two separate days, running under normal conditions. The upper part 710 of FIG. 7 shows the actual temperature measurements for two days. The health condition of the feed axis in those two days is normal. The first day begins at index 1, and the second day's measurement starts around index 780. When comparing the temperature values for the two days, it was found that the temperature values recorded during first day (both the ambient temperature and the bearing temperature) were slightly higher than those of the second day.

If the raw temperature measurements were used as input to the analysis models, the change from the first day to the second day would probably been seen in the output (MQE). In reality, however, there was no change in the condition of the feed axis from first day to the second day. To address that issue, a feature was selected to represent the consistent health condition though the temperature measurements varies each day. Considering the fact that the model of the bearing at the motor side and the end bearing is the same, it is reasonable to use the temperature difference of the bearing at the motor side and the end bearing instead of the temperature measurement itself The lower part 720 of FIG. 7 illustrates that there is a short transient period at the beginning of each day in which the absolute value of the temperature difference increases over time. That period is considered the warm-up time of the feed axis. The transition can be also seen in FIG. 4 where there are preceding ‘tails’ among different health conditions. It is difficult to diagnose the issues during the warm-up time. The lower part 720 of FIG. 7 shows the temperature difference of the bearing at the motor side and the end bearing over the same two days. It is obvious that this temperature difference is consistent (except at the beginning of each day) over the two days, even if the temperature itself varies. The difference between the temperature of the bearing at motor side and temperature of the end bearing was therefore used as one of the features that were input to the analysis models. The temperature difference was validated to have more significance than the raw values, because it contributes more than the raw temperature measurements to the second score (using principal component analysis mentioned in Liao and Paval). Another conclusion of the temperature-related findings is that additional attention must paid when using data collected during warm-up time for diagnosis purposes, since the non-uniform thermal expansion may lead to unreliable results.

Baseline Variation Issues and Model Update:

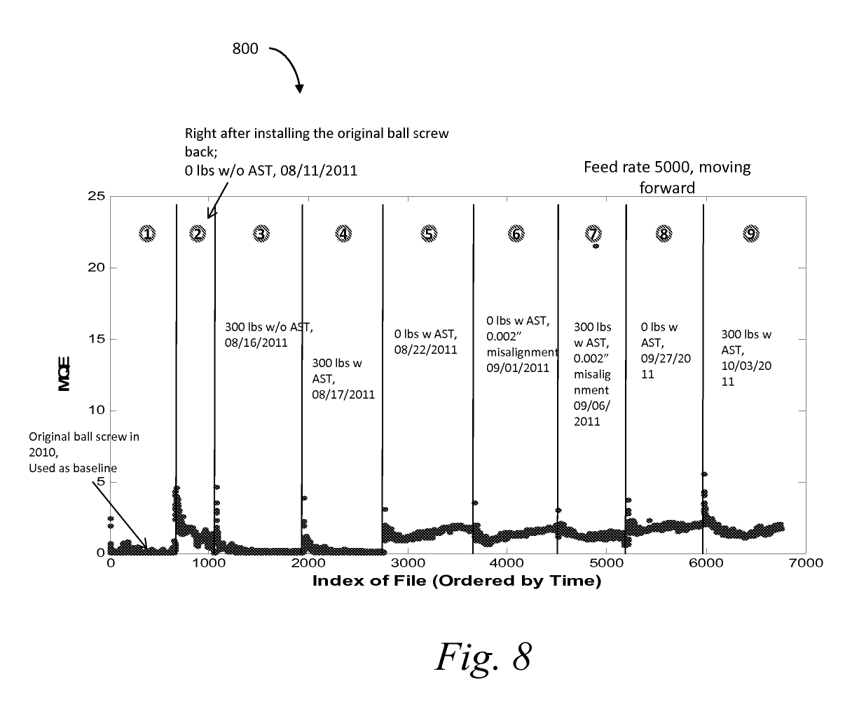

Although the same component (bearings, ball nut and ball screws) models were used in the trials, the system was actually different for each new installation of the same ball screw. An experiment was conducted to compare different baselines for different installations of the same ball screw, to its normal, reference condition. Nine sets of data, shown in the plot 800 of FIG. 8, were collected under the normal condition (baseline) for different new installations of the same feed axis components. The nine data sets provided slightly different MQE levels. The data includes running conditions of various weights, small amounts of preexisting misalignment, and with/without automatic server tuning (AST). AST is a function included in Siemens Sinumerik HMI which fully automates the tuning of control loops including speed loop proportional, integral gains, current set point filters and so on. The assumption is that the health indicator should show the actual health of the mechanical components no matter what settings are applied on them.

The data collected from the original ball screw installation was used as baseline and the rest of the data was tested against the adopted baseline using the anomaly detection method mentioned above. The output is the MQE values which indicate how different the nine conditions are. Conditions #3 and #4 are very close to the original installation. Condition #2 contains unexpected variance. Conditions #5 to #9 are similar but they seem to be drifting away from the original installation.

Overall, as compared to measurements shown in FIG. 4, the differences noticed between the nine normal conditions recorded after each installation are not significantly large. Therefore, in this particular case, the variation of the baseline cannot dramatically affect the anomaly detection results. This issue, however, may have significant effects in other applications.

Consequently, after replacement of the components due to maintenance activities, the model baseline may need to be updated. In addition, a normalized or ‘standard’ installation procedure may help minimize the variations in a system.

Method

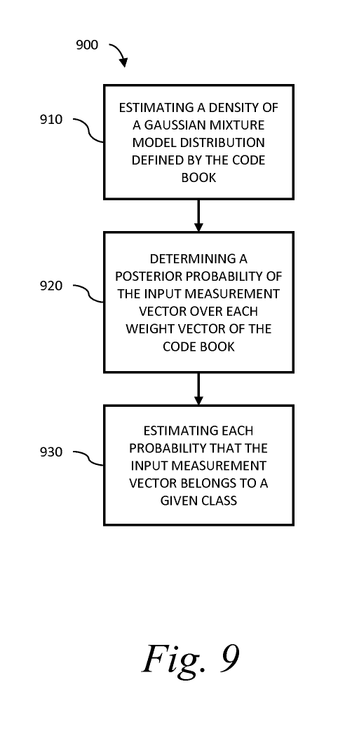

An exemplary method for identifying a fault class to which an input measurement vector belongs, the fault class corresponding to at least one weight vector in a code book of a self organized map describing a system based on training data, is illustrated by the flow chart 900 shown in FIG. 9. A density of a Gaussian mixture model distribution defined by the code book is estimated at block 910. A posterior probability of each weight vector of the code book given the input measurement vector is determined at block 920. Each probability that the input measurement vector belongs to a given class is then estimated at block 930. The estimation is based on the posterior probability of the at least one weight vector of the code book corresponding to the given class given the input measurement vector.

System

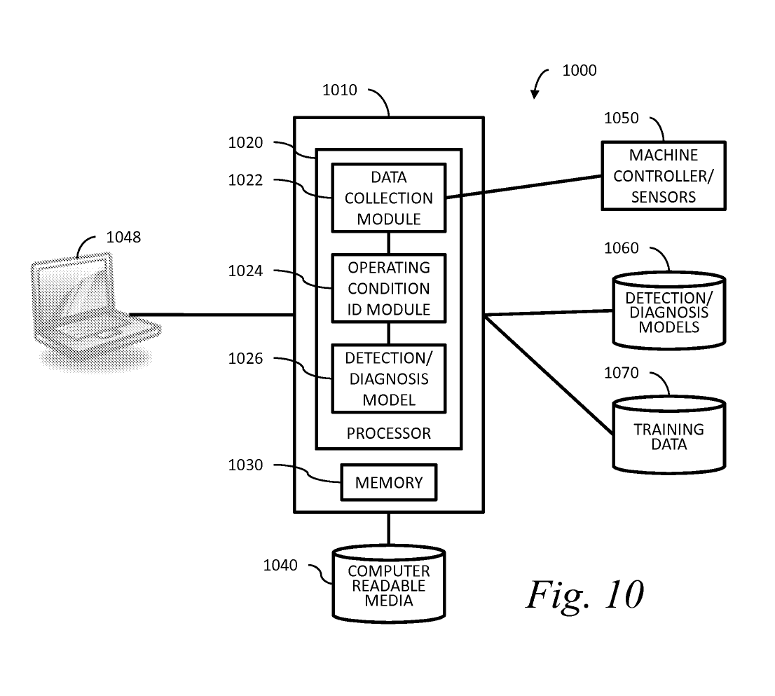

The elements of the methodology as described above may be implemented in a computer system comprising a single unit or a plurality of units linked by a network or a bus. An exemplary system 1000 is shown in FIG. 10.

A computing apparatus 1010 may be a mainframe computer, a desktop or laptop computer or any other device or group of devices capable of processing data. The computing apparatus 1010 receives data from any number of data sources that may be connected to the apparatus. For example, the computing apparatus 1010 may receive input from a user via an input/output device 1048, such as a computer or a computing terminal. The input/output device includes an input that may be a mouse, network interface, touch screen, etc., and an output that may be a visual display screen, a printer, etc. Input/output data may be passed between the computing apparatus 1010 and the input/output device 1048 via a wide area network such as the Internet, via a local area network or via a direct bus connection. The computing apparatus 1010 may be configured to operate and display information by using, e.g., the input/output device 1048 to execute certain tasks. In one embodiment, data acquisition is initiated via the input/output device 1048, and diagnosis results are displayed to the user via the same device.

The computing apparatus 1010 includes one or more processors 1020 such as a central processing unit (CPU) and further includes a memory 1030. The processor 1020, when configured using software according to the present disclosure, includes modules that are configured for performing one or more methods for identifying a fault class to which an input measurement vector belongs, as discussed herein. Those modules include a data collection module 1022 that receives and conditions data from external sensors and machine controllers 1050.

The modules also include an operating condition identification module 1024 that identifies operating conditions based on the operational data collected by the data collection module 1022, and further based on a model trained with training data 1070, as described above. Finally, detection/diagnosis models 1026 reside in the processor 1020. A plurality of detection/diagnosis models 1026 may be loaded into the processor, each corresponding to a single operating condition. Alternatively, a model 1026 for a particular operating condition may be loaded into the processor from a database 1060 after an operating condition is identified for a set of operational data.

The memory 1030 may include a random access memory (RAM) and a read-only memory (ROM). The memory may also include removable media such as a disk drive, tape drive, memory card, etc., or a combination thereof. The RAM functions as a data memory that stores data used during execution of programs in the processor 1020; the RAM is also used as a program work area. The ROM functions as a program memory for storing a program executed in the processor 1020. The program may reside on the ROM or on any other tangible or non-volatile computer-readable media 1040 as computer readable instructions stored thereon for execution by the processor to perform the methods of the invention. The ROM may also contain data for use by the program or by other programs.

Generally, the program modules 1022, 1024, 1026 described above include routines, objects, components, data structures and the like that perform particular tasks or implement particular abstract data types. The term “program” as used herein may connote a single program module or multiple program modules acting in concert. The disclosure may be implemented on a variety of types of computers, including personal computers (PCs), hand-held devices, multi-processor systems, microprocessor-based programmable consumer electronics, network PCs, mini-computers, mainframe computers and the like. The disclosed technique may also be employed in distributed computing environments, where tasks are performed by remote processing devices that are linked through a communications network. In a distributed computing environment, modules may be located in both local and remote memory storage devices.

An exemplary processing module for implementing the methodology above may be hardwired or stored in a separate memory that is read into a main memory of a processor or a plurality of processors from a computer readable medium such as a ROM or other type of hard magnetic drive, optical storage, tape or flash memory. In the case of a program stored in a memory media, execution of sequences of instructions in the module causes the processor to perform the process steps described herein. The embodiments of the present disclosure are not limited to any specific combination of hardware and software and the computer program code required to implement the foregoing can be developed by a person of ordinary skill in the art.

The term “computer-readable medium” as employed herein refers to any tangible machine-encoded medium that provides or participates in providing instructions to one or more processors. For example, a computer-readable medium may be one or more optical or magnetic memory disks, flash drives and cards, a read-only memory or a random access memory such as a DRAM, which typically constitutes the main memory. Such media excludes propagated signals, which are not tangible. Cached information is considered to be stored on a computer-readable medium. Common expedients of computer-readable media are well-known in the art and need not be described in detail here.

### CONCLUSION

The present disclosure presents techniques for reliably identifying the normal operation of a machine and diagnosing anomalous operating states. Testing was performed on a feed axis test bed which allowed fast application of sensors, programming of different scenarios for axis movements, and quick application of realistic faults and degradations without the risk of damaging an actual machine tool. The technology was also implemented on a vertical machining center (DMU50). Both systems were equipped with Siemens 840D controls.

Operational data was collected from the controller and was used both for labeling datasets into different operating conditions, and for the health state analysis, to help reduce false alarms. Experimental trials conducted on the feed-axis test-bed and the DMU50 machine demonstrated the effectiveness of technology for anomaly detection and diagnosis, and further demonstrated the capabilities of the technology to be applied on different types of applications. Some practical issues encountered throughout the tests were highlighted and discussed to provide additional insight.

The foregoing detailed description is to be understood as being in every respect illustrative and exemplary, but not restrictive, and the scope of the disclosure herein is not to be determined from the description, but rather from the claims as interpreted according to the full breadth permitted by the patent laws. It is to be understood that various modifications will be implemented by those skilled in the art, without departing from the scope and spirit of the disclosure.

What is claimed is:

1. A method for identifying a fault class to which an input measurement vector belongs, the fault class corresponding to at least one weight vector in a code book of a self organized map describing a system based on training data, the method comprising:
estimating a density of a Gaussian mixture model distribution defined by the code book;
determining a posterior probability of each weight vector of the code book given the input measurement vector; and
estimating each probability that the input measurement vector belongs to a given class, based on the posterior probability of the at least one weight vector of the code book corresponding to the given class given the input measurement vector.

2. A method as in claim 1, wherein the posterior probability of each weight vector j of the code book given the input measurement vector x is:
$$P ( j \vert x ) = \frac{p ( x \vert j ) P ( j )}{p ( x )} .$$

3. A method as in claim 2, wherein a probability that an input measurement vector x belongs to a given class c is:
P(c|x)=Σ_{∀j=c}P(j|x).

4. A method as in claim 1, wherein the system is a subsystem of a machine tool system.

5. A method as in claim 4, wherein the input measurement vector includes data received from a machine tool controller.

6. A method as in claim 1, wherein the input measurement vector includes data measured by at least one of an accelerometer and a thermocouple.

7. A method as in claim 1, wherein the training data is collected under a first operating condition and the input measurement vector is collected under a second operating condition.

8. A method as in claim 7, wherein the system is a subsystem of a machine tool system and each of the first and second operating conditions comprises at least one condition selected from a group consisting of a spindle speed, a feed rate, and an index of a particular cutting tool.

9. A method as in claim 1, wherein the training data is collected under a plurality of operating conditions, the training data further comprising a label indicating a fault class to which the training data belongs.

10. A method as in claim 9, wherein a different code book is constructed for each of the plurality of operating conditions.

11. A tangible computer-readable medium having stored thereon computer readable instructions for identifying a fault class to which an input measurement vector belongs, the fault class corresponding to at least one weight vector in a code book of a self organized map describing a system based on training data, wherein execution of the computer readable instructions by a processor causes the processor to perform operations comprising:
estimating a density of a Gaussian mixture model distribution defined by the code book;
determining a posterior probability of each weight vector of the code book given the input measurement vector; and
estimating each probability that the input measurement vector belongs to a given class, based on the posterior probability of the at least one weight vector of the code book corresponding to the given class given the input measurement vector.

12. A tangible computer-readable medium as in claim 11, wherein the posterior probability of each weight vector j of the code book given the input measurement vector x is:
$$P ( j \vert x ) = \frac{p ( x \vert j ) P ( j )}{p ( x )} .$$

13. A tangible computer-readable medium as in claim 12, wherein a probability that an input measurement vector x belongs to a given class c is
P(c|x)=Σ_{∀j=c}P(j|x).

14. A tangible computer-readable medium as in claim 11, wherein the system is a subsystem of a machine tool system.

15. A tangible computer-readable medium as in claim 14, wherein the input measurement vector includes data received from a machine tool controller.

16. A tangible computer-readable medium as in claim 11, wherein the input measurement vector includes data measured by at least one of an accelerometer and a thermocouple.

17. A tangible computer-readable medium as in claim 11, wherein the training data is collected under a first operating condition and the input measurement vector is collected under a second operating condition.

18. A tangible computer-readable medium as in claim 17, wherein the system is a subsystem of a machine tool system and each of the first and second operating conditions comprises at least one condition selected from a group consisting of a spindle speed, a feed rate, and an index of a particular cutting tool.

19. A tangible computer-readable medium as in claim 11, wherein the training data is collected under a plurality of operating conditions, the training data further comprising a label indicating a fault class to which the training data belongs.

20. A tangible computer-readable medium as in claim 19, wherein a different code book is constructed for each of the plurality of operating conditions.
